(19) United States
(12) Patent Application Publication
(10) Pub. No.: US 2010/0190089 A1
(43) Pub. Date: Jul. 29, 2010

(54) FUEL CELL

(76) Inventor: Takashi AKIYAMA, Osaka (JP)

Correspondence Address: MCDERMOTT WILL & EMERY LLP, 600 13TH STREET, NW, WASHINGTON, DC, 20005-3096, US

(21) Appl. No.: 12/689,552

(22) Filed: Jan. 19, 2010

(30) Foreign Application Priority Data
Jan. 23, 2009 (JP) 2009-013143

(51) Int. Cl. H01M 8/10

(52) U.S. Cl. 429/492; 429/508

(57) ABSTRACT

The present invention intends to provide a fuel cell being capable of preventing the methanol crossover in a simple and easy manner and being excellent in fuel utilization rate and the like. A fuel cell 30 of the present invention includes a polymer electrolyte membrane 11, an anode 23 and a cathode 25 sandwiching the polymer electrolyte membrane 11, an anode-side separator 17 having a fuel flow channel, a cathode-side separator 21 having an oxidant flow channel, and gaskets 26 and 27 interposed between the anode-side and cathode-side separators 17 and 21 and the periphery of the polymer electrolyte membrane 11. In the fuel cell 30, the orthographic projection area of the anode catalyst layer 31 included in the anode 23 seen from the direction normal to an MEA is set to be larger than the orthographic projection area of the anode porous substrate 15 included in the anode 23 seen from the direction normal to the MEA.

### FIELD OF THE INVENTION

The present invention relates to direct oxidation fuel cells, and specifically relates to an improvement of the cell structure in direct methanol fuel cells and the like.

### BACKGROUND OF THE INVENTION

Fuel cells can be classified into polymer electrolyte fuel cells, phosphoric acid fuel cells, alkaline fuel cells, molten carbonate fuel cells, solid oxide fuel cells, and the like, according to the type of electrolyte used therein. Among them, polymer electrolyte fuel cells (PEFCs), because of their low operational temperatures and high output densities, have been put into practical use as a power source for automobiles and for use in the home cogeneration systems.

Further, in recent years, the application of fuel cells as a power source for portable small-sized electronic devices such as laptop personal computers, cell phones, and personal digital assistants (PDAs) has been examined. Fuel cells can generate power continuously as long as fuel is supplied, and therefore, it is expected that using such fuel cells in place of secondary batteries, which require recharging, will enhance the convenience of use of the devices. In addition, the PEFCs, which are capable of low temperature operation, have been attracting attention as a promising power source for portable small-sized electronic devices.

Among such PEFCs, direct oxidation fuel cells provide an electric energy using a fuel that is liquid at room temperature by directly oxidizing the fuel without reforming it into hydrogen and require no reformer. For this reason, direct oxidation fuel cells are easy to be miniaturized. Among such direct oxidation fuel cells, direct methanol fuel cells (DMFCs) using methanol as the fuel have been regarded as the most promising power source for portable small-sized electronic devices, in view of the energy efficiency and the output power.

The reactions at the anode and the cathode in DMFCs can be expressed by the following reaction formulae (1) and (2), respectively. The oxygen to be introduced into the cathode is usually supplied from the air.

Anode: CH₃OH+H₂O→CO₂+6H⁺+6e⁻ (1)

Cathode: 3/2O₂+6H⁺+6e⁻→3H₂O (2)

In general, PEFCs, including DMFCs, each comprise a polymer electrolyte membrane, and an anode and a cathode facing each other with the polymer electrolyte membrane interposed therebetween. The anode has an anode catalyst layer and an anode diffusion layer disposed in this order on one surface of the polymer electrolyte membrane. The anode diffusion layer is composed of an anode water-repellent layer disposed in the polymer electrolyte membrane side and an anode porous substrate disposed in the separator side. The anode further has an anode-side separator. The anode-side separator is provided with a groove-like depression on the contact surface with the anode porous substrate, the depression forming a fuel flow channel for supplying a fuel to the anode catalyst layer.

On the other hand, the cathode has a cathode catalyst layer and a cathode diffusion layer disposed in this order on the other surface of the polymer electrolyte membrane. The cathode diffusion layer is composed of a cathode water-repellent layer disposed in the polymer electrolyte membrane side and a cathode porous substrate disposed in the separator side. The cathode further has a cathode-side separator. The cathode-side separator is provided with a groove-like depression on the contact surface with the cathode porous substrate, the depression forming an oxidant flow channel (air flow channel) for supplying an oxidant (air) to the cathode catalyst layer.

A stack of the anode, the polymer electrolyte membrane, and the cathode constitutes a basic unit called a cell. A unit consisting of the polymer electrolyte membrane and a pair of the catalyst layers is called a catalyst coated membrane (CCM), in which the power generation reaction of fuel cell occurs. A unit consisting of the CCM and a pair of the diffusion layers is called a membrane electrode assembly (MEA). The supplied fuel and air are uniformly dispersed in the pair of the diffusion layers, and reaction products such as water and carbon dioxide are smoothly discharged therefrom.

Japanese Laid-Open Patent Publication No. 2003-203646 discloses a production method in which the porous substrate is bonded with a gasket by using an adhesive in order to improve the ease of handling of such an MEA in a fuel cell.

### BRIEF SUMMARY OF THE INVENTION

One technical problem to be solved in the DMFCs and the like at present is to prevent the occurrence of a phenomenon in which part of the fuel (e.g., an aqueous methanol solution) supplied from the fuel flow channel reaches the cathode without passing through the anode catalyst layer, and is oxidized in the cathode catalyst layer. This phenomenon is called a methanol crossover (MOC), which is a cause of the deterioration in the utilization efficiency of fuel. Moreover, if the fuel reaches the cathode and is oxidized in the cathode catalyst layer, an oxygen reduction reaction occurs and a mixed potential is formed at the cathode, causing the potential at the cathode to be decreased, and thus resulting in a reduction in the power generation voltage and a deterioration in the power generation efficiency. In order to solve this problem, various attempts have been made to develop a polymer electrolyte membrane capable of reducing the permeation amount of methanol. However, in such a polymer electrolyte membrane, protons are conducted by the aid of the water present in the membrane. As such, the presence of water in the polymer electrolyte membrane is indispensable, and for this reason, it is impossible to sufficiently prevent the methanol from permeating together with the water through the polymer electrolyte membrane.

The movement of methanol in the electrolyte membrane is mainly due to the concentration diffusion. Accordingly, the amount of MCO representing the degree of MCO is greatly dependent on the difference in methanol concentration between the anode-side surface and the cathode-side surface of the polymer electrolyte membrane. The methanol concentration in the cathode-side surface of the polymer electrolyte membrane is negligibly small because the permeated methanol is rapidly oxidized at the cathode. This means that the amount of MCO is greatly dependent on the methanol concentration in the anode-side surface of the polymer electrolyte membrane. Further, at the anode, the methanol is consumed by the oxidation reaction in the anode catalyst layer. The diffusion rate of methanol is regulated by the material diffusion resistance in the anode water-repellent layer. Because of this, in general, the methanol concentration in an anode-side surface of the polymer electrolyte membrane is extremely smaller than the methanol concentration in the fuel flow channel.

However, due to the structural problem of MEAs, there is a portion where the methanol concentration in the anode-side surface of the polymer electrolyte membrane is not smaller than the methanol concentration in the fuel flow channel. The anode and cathode are normally surrounded by a gasket for preventing the leakage of fuel and air; however, in actual production process, it is difficult to completely seal the end surfaces of the anode and cathode with the gasket with no clearance formed therebetween. As such, a clearance is present more or less between the end surfaces of the anode and cathode and the gasket, creating a region between the anode porous substrate receiving the supply of fuel from the fuel flow channel and the polymer electrolyte membrane, the region in which neither the anode catalyst layer nor the anode water-repellent layer is present. Due to the presence of this region, part of the methanol supplied from the fuel flow channel reaches the polymer electrolyte membrane with its concentration being maintained, and permeates through the interior thereof. As a result, the concentration gradient of methanol in the anode-side surface and the cathode-side surface of the polymer electrolyte membrane increases, resulting in a local increase of the amount of MCO.

On the other hand, by applying the production method disclosed in Japanese Laid-Open Patent Publication No. 2003-203646, it is possible to prevent a high concentration fuel (e.g., an aqueous methanol solution) from passing through the clearance between the end surfaces of the anode and cathode and the gasket. However, the entrance of organic substance or cation is harmful to a fuel cell. This is because the organic substance is adsorbed on the surface of a catalyst in the anode catalyst layer and the like, and decreases the catalytic activity; and the cation exchanges the ion exchange group of the polymer electrolyte membrane, and decreases the proton conductivity. In the case of bonding the porous substrate with the gasket using an adhesive as in the production method disclosed in Japanese Laid-Open Patent Publication No. 2003-203646, the organic substance or cation is discharged from the components of the adhesive, the impurities that have entered in the bonding process, and the like, which may reduce over time the catalytic activity of the catalyst layer and the ion conductivity of the polymer electrolyte membrane. Moreover, in the production method disclosed in Japanese Laid-Open Patent Publication No. 2003-203646, the adhesive must be applied with extremely high dimensional accuracy, which makes the production process complicated and difficult.

In view of the above, the present invention intends to solve the above-discussed technical problems and prevent the occurrence of a phenomenon such as methanol crossover in which part of the fuel supplied from the fuel flow channel passes through the polymer electrolyte membrane and is oxidized at the cathode, in an easy and simple manner, thereby to provide a fuel cell excellent in the fuel utilization efficiency, and the power generation performance such as the power generation voltage and power generation efficiency.

A fuel cell according to one aspect of the present invention includes: a membrane electrode assembly including a polymer electrolyte membrane with hydrogen ion conductivity, and an anode and a cathode sandwiching the polymer electrolyte membrane; an anode-side separator having a fuel flow channel for supplying a fuel to the anode; a cathode-side separator having an oxidant flow channel for supplying an oxidant to the cathode; and a gasket being interposed at least either between the anode-side separator and a periphery of the polymer electrolyte membrane or between the cathode-side separator and the periphery of the polymer electrolyte membrane so as to surround the anode or the cathode, and compressing, together with the anode-side separator and the cathode-side separator, the polymer electrolyte membrane in its thickness direction, and is characterized in that: the anode includes an anode catalyst layer being in contact with the polymer electrolyte membrane, and an anode diffusion layer being in contact with the anode-side separator; the anode diffusion layer includes an anode water-repellent layer being in contact with the anode catalyst layer, and an anode porous substrate being in contact with the anode-side separator; and the orthographic projection area of the anode catalyst layer seen from the direction normal to the membrane electrode assembly is larger than the orthographic projection area of the anode porous substrate seen from the direction normal to the membrane electrode assembly.

According to the present invention, it is possible to prevent the occurrence of a phenomenon in which a high concentration fuel passes through a clearance between the end surface of the anode and the gasket, and the unreacted fuel permeates through the polymer electrolyte membrane. As such, with respect to fuel cells, it is possible to prevent the deterioration in the fuel utilization efficiency and the reduction in the power generation voltage, power generation efficiency, and the like.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 is a schematic cross-sectional view showing a first embodiment of a fuel cell of the present invention;

FIG. 2 is a schematic cross-sectional view showing a second embodiment of the fuel cell of present invention;

FIG. 3 is a schematic cross-sectional view showing a third embodiment of the fuel cell of present invention;

FIG. 4 is a schematic cross-sectional view showing a fourth embodiment of the fuel cell of present invention;

FIG. 5 is a schematic cross-sectional view showing a fifth embodiment of the fuel cell of present invention;

FIG. 6 is a schematic cross-sectional view showing a fuel cell fabricated in Comparative Example 1; and

FIG. 7 is a schematic cross-sectional view showing a fuel cell fabricated in Comparative Example 2.

### DETAILED DESCRIPTION OF THE INVENTION

A fuel cell of the present embodiment includes: a membrane electrode assembly (MEA) including a polymer electrolyte membrane with hydrogen ion conductivity, and an anode and a cathode sandwiching the polymer electrolyte membrane; an anode-side separator having a fuel flow channel for supplying a fuel to the anode; a cathode-side separator having an oxidant flow channel for supplying an oxidant to the cathode; and a gasket being interposed at least either between the anode-side separator and a periphery of the polymer electrolyte membrane or between the cathode-side separator and the periphery of the polymer electrolyte membrane so as to surround the anode or the cathode, and compressing, together with the anode-side separator and the cathode-side separator, the polymer electrolyte membrane in its thickness direction.

In the fuel cell of the present embodiment, the anode includes an anode catalyst layer being in contact with the polymer electrolyte membrane, and an anode diffusion layer being in contact with the anode-side separator. The anode diffusion layer includes an anode water-repellent layer being in contact with the anode catalyst layer, and an anode porous substrate being in contact with the anode-side separator. Further, the orthographic projection area of the anode catalyst layer seen from the direction normal to the MEA is larger than the orthographic projection area of the anode porous substrate seen from the direction normal to the MEA.

The MEA in a fuel cell is generally formed by bonding a CCM comprising a polymer electrolyte membrane and a pair of catalyst layers with an anode diffusion layer and a cathode diffusion layer. Specifically, a material for forming an anode catalyst layer is applied onto one surface of a polymer electrolyte membrane, and a material for forming a cathode catalyst layer is applied onto the other surface of the polymer electrolyte membrane, followed by drying these to form a CCM. Separately from this, a material for forming an anode water-repellant layer and a material for forming a cathode water-repellant layer are applied onto one surface of the anode porous substrate and one surface of the cathode porous substrate, respectively, to form an anode diffusion layer and a cathode diffusion layer. Thereafter, the anode diffusion layer, the CCM, and the cathode diffusion layer are stacked and bonded by heat pressing or other methods, whereby an MEA is obtained.

The configuration in which the orthographic projection area of the anode catalyst layer seen from the direction normal to the MEA is larger than the orthographic projection area of the anode porous substrate seen from the direction normal to the MEA is enabled by a simple and easy method of, for example, in forming the CCM, setting the application region of a material for forming an anode catalyst layer to be large, so that the area of the anode catalyst layer thus formed becomes larger that of the anode porous substrate.

When the orthographic projection area of the anode catalyst layer seen from the direction normal to the MEA is set to be larger than the orthographic projection area of the anode porous substrate seen from the direction normal to the MEA, if a clearance is formed between the end surface of the anode porous substrate and the gasket, on a portion of the polymer electrolyte membrane corresponding to the clearance, the anode catalyst layer is present. As such, it is possible to prevent the occurrence of a phenomenon in which part of the fuel supplied from the fuel flow channel to the anode porous substrate reaches the polymer electrolyte membrane, permeates through the polymer electrolyte membrane and is oxidized in the cathode catalyst layer. This makes it possible to provide a fuel cell excellent in the fuel utilization efficiency, and the power generation performance such as the power generation voltage and power generation efficiency.

In the fuel cell of the present embodiment, it is preferable that the anode catalyst layer covers at least part of an end surface of the anode diffusion layer, or alternatively, the anode water-repellent layer covers at least part of an end surface of the anode porous substrate. In this case, it is possible to more reliably prevent part of the fuel supplied from the fuel flow channel to the anode porous substrate from passing through the polymer electrolyte membrane without passing through the anode catalyst layer to reach the cathode catalyst layer. This makes it possible to provide a fuel cell extremely excellent in the fuel utilization efficiency, and the power generation performance such as the power generation voltage and power generation efficiency.

In the case where the anode catalyst layer covers at least part of an end surface of the anode diffusion layer, in the foregoing fuel cell, the gasket is interposed between the cathode-side separator and the periphery of the polymer electrolyte membrane; and the periphery of the polymer electrolyte membrane is bent so as to be in contact with the anode-side separator and to cover a portion of the anode catalyst layer covering at least part of an end surface of the anode diffusion layer. In this case also, it is possible to more reliably prevent part of the fuel supplied from reaching the cathode catalyst layer without passing through the anode catalyst layer.

In the case where the anode catalyst layer covers at least part of an end surface of the anode diffusion layer, in the foregoing fuel cell, the gasket preferably compresses the periphery of the polymer electrolyte membrane onto to anode-side separator. In this case, unit cells of the fuel cell can be more tightly sealed.

In the fuel cell of the present embodiment, it is preferable that the anode catalyst layer covers an entire end surface of the anode diffusion layer, or alternatively, the anode water-repellent layer covers an entire end surface of the anode porous substrate. In this case also, it is possible to more reliably prevent part of the fuel supplied from the fuel flow channel to the anode porous substrate from reaching the cathode catalyst layer without passing through the anode catalyst layer.

Now referring to the drawings, embodiments of the present invention are described in detail. In the description below, the same or the same type of components in several embodiments are denoted by the same reference numeral, and the description thereof is omitted.

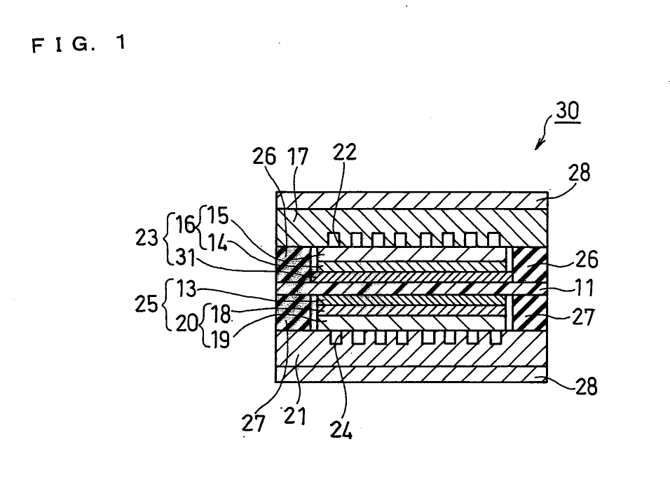

Referring to FIG. 1 showing a first embodiment, a fuel cell 30 includes a polymer electrolyte membrane 11 with hydrogen ion conductivity, an anode 23 and a cathode 25 arranged so as to face each other with the polymer electrolyte membrane 11 interposed therebetween, an anode-side separator 17 arranged on the side of the anode 23 opposite to the polymer electrolyte membrane 11, a cathode-side separator 21 arranged on the side of the cathode 25 opposite to the polymer electrolyte membrane 11, a pair of gaskets 26 and 27 interposed between the anode-side separator 17 and the polymer electrolyte membrane 11 and between the cathode-side separator 21 and the polymer electrolyte membrane 11.

The anode 23 has an anode catalyst layer 31 being in contact with the polymer electrolyte membrane 11, and an anode diffusion layer 16 being in contact with the anode side separator 17. Further, the anode diffusion layer 16 has an anode water-repellent layer 14 being in contact with the anode catalyst layer 31, and an anode porous substrate 15 being in contact with the anode side separator 17.

The cathode 25 has a cathode catalyst layer 13 being in contact with the polymer electrolyte membrane 11, and a cathode diffusion layer 20 being in contact with the cathode side separator 21. Further, the cathode diffusion layer 20 has a cathode water-repellent layer 18 being in contact with the cathode catalyst layer 13, and a cathode porous substrate 19 being in contact with the cathode side separator 21.

The polymer electrolyte membrane 11 is in the form of a film or a sheet, and is a member being rectangular in shape in plan view. Likewise, the layers stacked on both sides of the polymer electrolyte membrane 11, namely, the anode catalyst layer 31, the anode diffusion layer 16, the cathode catalyst layer 13, and the cathode diffusion layer 20, are all formed into a rectangular shape in plan view. However, the shapes of the polymer electrolyte membrane, anode catalyst layer, anode diffusion layer, cathode catalyst layer, and cathode diffusion layer are not limited to a rectangular shape in plan view, and may be formed into any shape according to a desired overall shape of the fuel cell. Specifically, in addition to a rectangular shape, the shape may be an appropriately selected shape, which is exemplified by a polygonal shape such as a triangle shape and a hexagonal shape.

For the polymer electrolyte membrane 11, various polymer electrolyte membranes known in the field of fuel cells may be used without particular limitation, as long as they have hydrogen ion conductivity. The polymer electrolyte membranes commercially available at present are mainly of proton conductive type.

Examples of the polymer electrolyte membrane 11 includes fluorine-based polymer membranes, which are exemplified by a film containing a perfluorosulfonic acid polymer such as a perfluorosulfonic acid/polytetrafluoroethylene copolymer (H⁺ type), and the like. The above film containing a perfluorosulfonic acid polymer is, for example, Naf ion membrane (product name: “Naf ion (registered trademark)”, available from E.I. du Pont de Nemours and Company) or the like.

Further, the polymer electrolyte membrane 11 preferably is a membrane having an effect of reducing the crossover of the fuel (e.g., methanol) used for the fuel cell 30. Examples of such a membrane include, in addition to the fluorine-base polymer membrane as described above, a hydrocarbon-based polymer that does not contain fluorine atoms such as sulfonated polyether ether ketone (S-PEEK), an inorganic/organic composite membrane, and the like.

The anode catalyst layer 31 contains a catalyst for facilitating the reaction represented by the foregoing reaction formula (1), and a polymer electrolyte for ensuring the ion conductivity with the polymer electrolyte membrane 11.

Examples of the catalyst contained in the anode catalyst layer 31 include an alloy of platinum (Pt) and ruthenium (Ru), a mixture of Pt and a ruthenium oxide, a ternary alloy of Pt, Ru and a metal element other than Pt and Ru (e.g., iridium). In the alloy of Pt and Ru, although not limited thereto, the atomic ratio of Rt to Ru is preferably 1:1. The catalyst contained in the anode catalyst layer 31 may be used in the form of a fine powder of the above alloy, or alternatively, may be used by allowing the above alloy to adhere onto a powder with electron conductivity such as carbon black.

Examples of the polymer electrolyte contained in the anode catalyst layer 31 include a perfluorosulfonic acid/polytetrafluoroethylene copolymer (H⁺ type), sulfonated polyethersulfone (H⁺ type), and aminated polyethersulfone (OH⁻ type).

The cathode catalyst layer 13 contains a catalyst for facilitating the reaction represented by the foregoing reaction formula (2), and a polymer electrolyte for ensuring the ion conductivity with the polymer electrolyte membrane 11.

Examples of the catalyst contained in the cathode catalyst layer 13 include simple Pt, or an alloy of Pt and a transition metal such as cobalt and iron. The catalyst contained in the cathode catalyst layer 13 may be used in the form of a fine powder of the above metal or alloy, or alternatively, may be used by allowing the above metal or alloy to adhere onto a powder with electron conductivity such as carbon black.

Examples of the polymer electrolyte contained in the cathode catalyst layer 13 are the same as those exemplified as the polymer electrolyte contained in the anode catalyst layer 31.

The anode catalyst layer 31 and the cathode catalyst layer 13 can be obtained by dispersing the catalyst and the polymer electrolyte in an appropriately selected dispersion medium, applying an ink obtained in such a manner onto the polymer electrolyte membrane 11, and then drying the ink. The application of the ink may be performed by spraying, squeegeeing, and the like.

A stack of the anode catalyst layer 31, the polymer electrolyte membrane 11, and the cathode catalyst layer 13 (i.e., a CCM) can be produced by applying the above ink onto surfaces of resin sheets and drying the ink, placing the anode catalyst layer 31 and the cathode catalyst layer 13 obtained in such a manner on both surfaces of the polymer electrolyte membrane 11, respectively, and transferring the catalyst layers onto the polymer electrolyte membrane 11 from the resin sheets by heat pressing.

The anode diffusion layer 16 and the cathode diffusion layer 20 are each provided with a porous substrate having been subjected to water repellent treatment and a water-repellent layer formed on the surface of the porous substrate, the water repellent layer being made of a material excellent in water repellency.

Examples of the porous substrate used as the anode porous substrate 15 and the cathode porous substrate 19 include carbon paper, carbon cloth, carbon nonwoven fabric (carbon felt) or the like made of carbon fiber; and metal mesh, foamed metal or the like having corrosion resistance.

Examples of the highly water-repellent material used for the formation of the anode water-repellent layer 14 and the cathode water-repellent layer 18 include fluorine-based polymer and fluorinated graphite, and more specifically, polytetrafluoroethylene (PTFE) particles and the like.

The anode diffusion layer 16 and the cathode diffusion layer 20 can be obtained in the following manner. First, a highly water-repellent material such as fluorine-based polymer, and a material having electric conductivity and being capable of forming micropores, and an appropriately selected dispersion medium were mixed and stirred together. For the material having electric conductivity and being capable of forming micropores, carbon black, such as furnace black and acetylene black; graphite powder; porous metal powder; and the like may be used. The ink obtained in such a manner is applied onto the surface of the porous substrate having been subjected to water repellent treatment, and then dried. The application of the ink may be performed by screen printing, squeegeeing, and the like.

The anode diffusion layer 16 and the cathode diffusion layer 20 obtained in such a manner were placed on both surfaces of the stack of the anode catalyst layer 31, the polymer electrolyte membrane 11, and the cathode catalyst layer 13 (i.e., the CCM), and these were bonded together by heat pressing. In such a manner, an MEA in which the anode 23, the polymer electrolyte membrane 11, and the cathode 25 are stacked in this order is produced.

The anode-side separator 17 and the cathode-side separator 21 are made of a carbon material such as graphite, and are each provided with a groove-like depression for forming a fuel flow channel for supplying a fuel (e.g., an aqueous methanol solution) or an oxidant (e.g., air or oxygen).

The depression provided on the surface of the anode-side separator 17 forms a fuel flow channel 22 at the interface with the anode porous substrate 15. On the other hand, the depression provided on the surface of the cathode-side separator 21 forms an air flow channel 24 at the interface with the cathode porous substrate 19.

The fuel flow channel 22 of the anode-side separator 17 and the air flow channel 24 of the cathode-side separator 21 are formed, for example, by forming a groove-like cut-out on the surface of the separator. Alternatively, the fuel flow channel 22 and the air flow channel 24 may be formed by molding when the separator itself is produced by molding (e.g., injection molding or compression molding).

For the gaskets 26 and 27, for example, fluorine-based polymer, such as PTFE and polytetrafluoroethylene-hexafluoropropylene copolymer (FEP); synthetic resin, such as fluorine rubber, ethylene-propylene-diene rubber (EPDM); silicone elastomer; and the like may be used.

The gaskets 26 and 27 are each made of a sheet made of PTFE or the like provided with a cut-out portion in the center thereof, the cut-out portion having nearly the same area as that of the membrane electrode assembly (MEA). The pair of the gaskets 26 and 27 are disposed on the surfaces of the MEA, respectively, so as to be in contact with the end surfaces of the anode catalyst layer 31 and the cathode catalyst layer 13.

The pair of the gaskets 26 and 27, together with the pair of the separators 17 and 21, compress the polymer electrolyte membrane 11 in its thickness direction.

The cell composed of the membrane electrode assembly (MEA) comprising the anode 23, the polymer electrolyte membrane 11, and the cathode 25, and the pair of the separators 17 and 21 disposed on both sides of the MEA is sandwiched by end plates 28 disposed on the outside of the separator, and then clamped by bolts or screws (not shown). The interfaces between the MEA bonded by heat pressing, and the pair of the separators 17 and 21 are poor in adhesion. However, the adhesion to each other can be enhanced by clamping the cell as described above, resulting in a reduced contact resistance between the MEA and the pair of the separators 17 and 21.

A plurality of the above cells may be stacked to be used as a cell stack.

In the fuel cell 30 of FIG. 1, the orthographic projection area of the anode catalyst layer 31 seen from the normal direction is set to be larger than the anode catalyst layer 31 of the anode porous substrate 15 seen from the normal direction.

It may occur that a clearance is formed between the end surface of the anode porous substrate 15 and the gasket 26 because of the factors in the production process, for example, the variation in size, the displacement, and the like among the layers forming the anode 23. However, by setting the orthographic projection areas of the anode catalyst layer 31 and the anode porous substrate 15 as described above, the anode catalyst layer 31 is surely present between the anode porous substrate 15 and the polymer electrolyte membrane 11.

As such, it is possible to prevent the occurrence of the phenomenon (e.g., MCO) in which part of the fuel supplied from the fuel flow channel 22 to the anode porous substrate 15 reaches the polymer electrolyte membrane 11 without passing through the anode catalyst layer 31, permeates through the polymer electrolyte membrane 11, and is oxidized in the cathode catalyst layer 13.

The magnitude of the difference between the orthographic projection area of the anode catalyst layer 31 seen from the normal direction and the orthographic projection area of the anode porous substrate 15 seen from the normal direction is not particularly limited. However, in the above-described embodiment, it is preferable that the difference in position between the end surface of the anode catalyst layer 31 and the end surface of the gasket 26 in the anode side is as small as possible. The difference in position between end plates is dependent on the size of the anode catalyst layer 31, the dimensional accuracy of the cut-out portion of the gasket 26, the positioning accuracy of the anode catalyst layer 31 and the gasket 26, and other factors. For example, assuming that the size of the anode catalyst layer 31 and the dimensional accuracy of the cut-out portion of the gasket 26 show up as a difference of ±0.1 mm between the position of the end surface of the anode catalyst layer 31 and that of the gasket 26, and the positioning accuracy of the anode catalyst layer 31 and the gasket 26 is ±0.1 mm, it is preferable that the length of the anode catalyst layer 31 in the direction along the surface of the polymer electrolyte membrane 11 (i.e., the length of any one side of the anode catalyst layer 31 in plan) be set to be 0.2 mm or more greater, preferably about 0.3 to 0.4 mm greater, than the corresponding length of the anode porous substrate 15 (i.e., the length of the corresponding side thereof).

The gasket 26 disposed in the anode 23 side may be in contact with the surface of the anode catalyst layer 31 in the anode diffusion layer 16 side, and in such a state, may compress, together with the gasket 27 disposed in the cathode side, the polymer electrolyte membrane 11 in its thickness direction. In this case, it is possible to surely prevent a gap from being formed between the gasket 26 and the anode catalyst layer 31.

The configuration of the fuel cell 30 shown in FIG. 1 is suitable for improving the fuel utilization efficiency, and the power generation performance such as the power generation voltage and power generation efficiency.

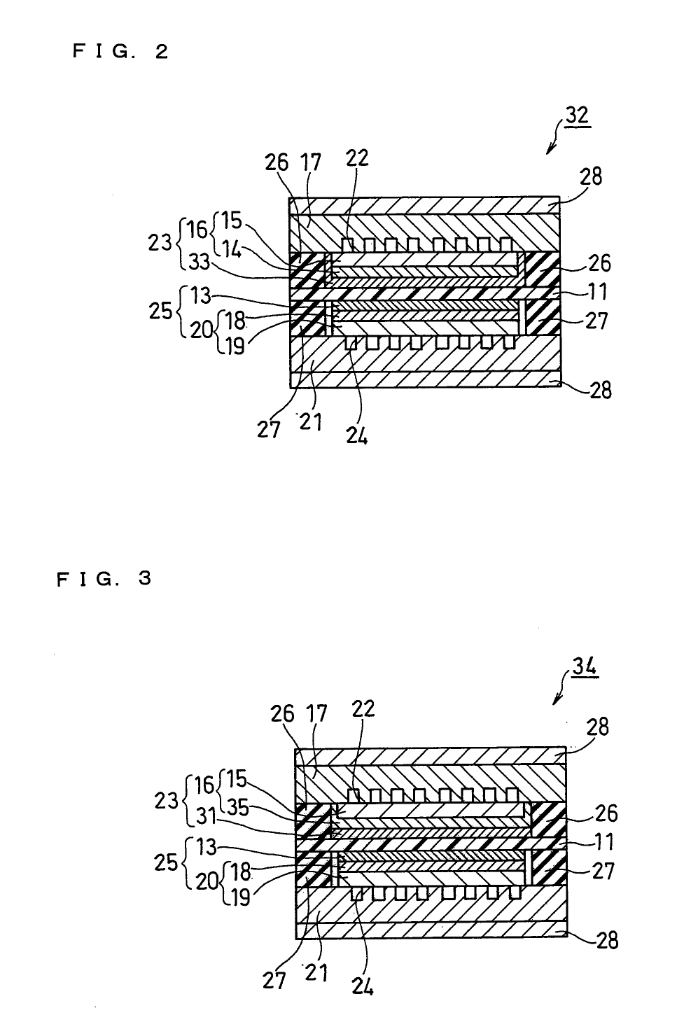

Referring to FIG. 2 showing a second embodiment, a fuel cell 32, like the fuel cell 30 of FIG. 1, includes the anode-side separator 17, the anode 23, the polymer electrolyte membrane 11, the cathode 25, the cathode-side separator 21, the pair of the gaskets 26 and 27 interposed between the pair of the separators 17 and 21 and the polymer electrolyte membrane 11, and the pair of the end plates 28.

The anode 23 has an anode catalyst layer 33 being in contact with the polymer electrolyte membrane 11, and the anode diffusion layer 16 being in contact with the anode side separator 17. The anode catalyst layer 33 contains a catalyst for facilitating the reaction represented by the foregoing reaction formula (1), and a polymer electrolyte for ensuring the ion conductivity with the polymer electrolyte membrane 11.

Examples of the catalyst contained in the anode catalyst layer 33 are the same as those exemplified as the catalyst contained in the anode catalyst layer 31 of FIG. 1.

The fuel cell 32 of FIG. 2, the anode catalyst layer 33 covers an entire end surface of the anode diffusion layer 16. In order to cover the entire end surface of the anode diffusion layer 16 with the anode catalyst layer 33, the anode catalyst layer 33 is formed by applying an ink for forming an anode catalyst layer onto the surface of the anode diffusion layer 16 in the anode water-repellent layer 14 side, and drying the ink. Specifically, in applying the ink for forming an anode catalyst layer, the end surface of the anode diffusion layer 16 is left unmasked, and the application of the ink for forming an anode catalyst layer is performed while the end surface is exposed. By doing this, the anode catalyst layer 33 can be formed not only on the surface of the anode diffusion layer 16 in the anode water-repellent layer 14 side but also on the end surface of the anode diffusion layer 16. For the ink for forming an anode catalyst layer, the same ink as used for forming the anode catalyst layer 31 of FIG. 1 may be used.

In the fuel cell 32 of FIG. 2, the orthographic projection area of the anode catalyst layer 33 seen from the normal direction is set to be larger than the orthographic projection area of the anode porous substrate 15 seen from the normal direction. By setting the areas as described above, the anode catalyst layer 33 is surely present between the anode porous substrate 15 and the polymer electrolyte membrane 11 in the clearance formed between the anode porous substrate 15 and the gasket 26. Further, in the fuel cell 32 of FIG. 2, the end surface of the anode diffusion layer 16 is covered with the anode catalyst layer 33.

As such, it is possible to more reliably prevent the occurrence of the phenomenon (e.g., MCO) in which part of the fuel supplied from the fuel flow channel 22 to the anode porous substrate 15 reaches the polymer electrolyte membrane 11 without passing through the anode catalyst layer 33, permeates through the polymer electrolyte membrane 11, and is oxidized in the cathode catalyst layer 13.

The magnitude of the difference between the orthographic projection area of the anode catalyst layer 33 seen from the normal direction and the orthographic projection area of the anode porous substrate 15 seen from the normal direction is not particularly limited. However, in the above-described embodiment, it is preferable to set the relationship between the length of the anode catalyst layer 33 in the direction along the surface of the polymer electrolyte membrane 11 (i.e., the length of any one side thereof) and the corresponding length of the anode porous substrate 15 (i.e., the length of the corresponding side thereof) to be the same as the relationship between the lengths of the anode catalyst layer 31 and the anode porous substrate 15 in the fuel cell 30 of FIG. 1.

The configuration of the fuel cell 32 shown in FIG. 2 is extremely suitable for improving the fuel utilization efficiency, and the power generation performance such as the power generation voltage and power generation efficiency.

Referring to FIG. 3 showing a third embodiment, a fuel cell 34, like the fuel cell 30 of FIG. 1, includes the anode-side separator 17, the anode 23, the polymer electrolyte membrane 11, the cathode 25, the cathode-side separator 21, the pair of the gaskets 26 and 27 interposed between the pair of the separators 17 and 21 and the polymer electrolyte membrane 11, and the pair of the end plates 28.

The anode 23 has the anode catalyst layer 31 and the anode diffusion layer 16. The anode diffusion layer 16 further has an anode water-repellent layer 35 being in contact with the anode catalyst layer 31, and the anode porous substrate 15. The anode water-repellent layer 35 covers the entire end surface of the anode porous substrate 15.

In order to cover the entire end surface of the anode porous substrate 15 with the anode water-repellent layer 35, the anode water-repellent layer 35 is formed in the following manner. For example, in forming the anode diffusion layer 16, the end surface of the anode porous substrate 15 is left unmasked, and the application of the ink for forming an anode water-repellent layer is performed while the end surface is exposed. By doing this, the anode water-repellent layer 35 can be formed not only on the surface of the anode porous substrate 15 in the anode catalyst layer 31 side but also on the end surface of the anode porous substrate 15. For the ink for forming an anode water-repellent layer, the same ink as used for forming the anode water-repellent layer 14 of FIG. 1 may be used.

In the fuel cell 34 of FIG. 3, the orthographic projection area of the anode catalyst layer 31 seen from the normal direction is set to be larger than the orthographic projection area of the anode porous substrate 15 seen from the normal direction. By setting the areas as described above, the anode catalyst layer 31 is surely present between the anode porous substrate 15 and the polymer electrolyte membrane 11 in the clearance formed between the anode porous substrate 15 and the gasket 26. Further, in the fuel cell 34 of FIG. 3, the end surface of the anode porous substrate 15 is covered with the anode water-repellent layer 35.

As such, it is possible to more reliably prevent the occurrence of the phenomenon (e.g., MCO) in which part of the fuel supplied from the fuel flow channel 22 to the anode porous substrate 15 reaches the polymer electrolyte membrane 11 without passing through the anode catalyst layer 31, permeates through the polymer electrolyte membrane 11, and is oxidized in the cathode catalyst layer 13.

The magnitude of the difference between the orthographic projection area of the anode catalyst layer 31 seen from the normal direction and the orthographic projection area of the anode porous substrate 15 seen from the normal direction is not particularly limited. However, in the above-described embodiment, it is preferable to set the relationship between the length of the anode catalyst layer 31 in the direction along the surface of the polymer electrolyte membrane 11 (i.e., the length of any one side thereof) and the corresponding length of the anode porous substrate 15 (i.e., the length of the corresponding side thereof) to be the same as in the fuel cell 30 of FIG. 1.

The configuration of the fuel cell 34 shown in FIG. 3 is extremely suitable for improving the fuel utilization efficiency, and the power generation performance such as the power generation voltage and power generation efficiency.

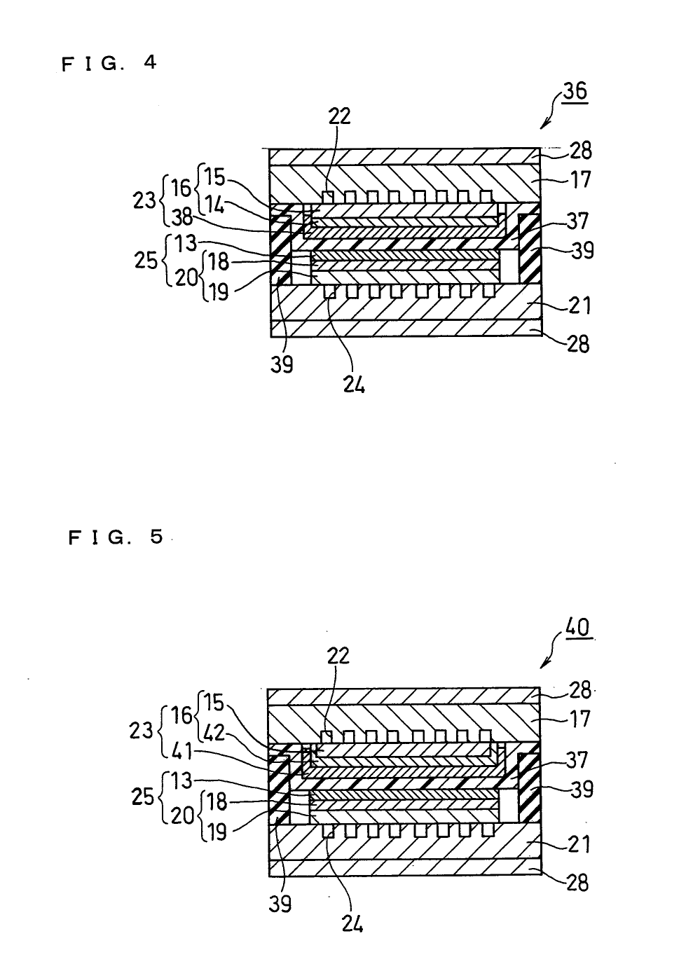

Referring to FIG. 4 showing a fourth embodiment, a fuel cell 36 includes the anode-side separator 17, the anode 23, a polymer electrolyte membrane 37, the cathode 25, the cathode-side separator 21, a gasket 39 interposed between the pair of the separators 17 and 21 and the polymer electrolyte membrane 11, and the pair of the end plates 28.

The anode 23 has an anode catalyst layer 38 being in contact with the polymer electrolyte membrane 37, and the anode diffusion layer 16.

The polymer electrolyte membrane 37 is the same as the polymer electrolyte membrane 11 in the fuel cell 30 of FIG. 1, except that the polymer electrolyte membrane 37 is bent around the anode 23. The periphery of the polymer electrolyte membrane 37 is bent toward the anode-side separator 17 and is brought into contact with the anode-side separator 17.

The anode catalyst layer 38 is bent together with the polymer electrolyte membrane 37 toward the anode-side separator 17, and partially covers the end surface of the anode diffusion layer 16.

The gasket 39 is the same as the gaskets 26 and 27 in the fuel cell 30 of FIG. 1 except that the gasket 39 is provided only between the polymer electrolyte membrane 37 and the cathode-side separator 21. The top surface of the gasket 39 presses the periphery of the polymer electrolyte membrane 37 to the anode-side separator 17.

By bending the polymer electrolyte membrane 37 and disposing the gasket 39 only between the polymer electrolyte membrane 37 and the cathode-side separator 21, the number of gaskets can be decreased, and thus the material costs can be reduced. In addition, by doing this, the cell assembly process can be simplified. In this case, the sealing of the cathode 25 is ensured by the tight fit between the gasket 39 and the polymer electrolyte membrane 37; and the sealing of the anode 23 is ensured by the tight fit between the polymer electrolyte membrane 37 and the anode-side separator 17.

In order to increase the ratio of the area of the anode 23 or the cathode 25 to the area of the cell or the stack, it is also considered effective to significantly reduce the width of the gasket, specifically, to use a linear gasket having a small width instead of the sheet-like gasket. However, in this case, in disposing a pair of gaskets on both surfaces of the polymer electrolyte membrane, highly accurate positioning is required with regard to the mutual positional relationship between a pair of these gaskets. For this reason, in the case of using a linear gasket, the configuration in which the gasket 39 is provided only between the polymer electrolyte membrane 37 and the cathode-side separator 21 is effective.

The area of the anode catalyst layer 38 formed on the polymer electrolyte membrane 37 is set to be large as compared with the area of the anode diffusion layer 16 (and the anode porous substrate 15) so that the end surface of the anode diffusion layer 16 can be covered with the anode catalyst layer 38. Accordingly, in the direction normal to the anode porous substrate 15, the orthographic projection area of the anode catalyst layer 38 is larger than the orthographic projection area of the anode porous substrate 15.

The magnitude of the difference between the orthographic projection area of the anode catalyst layer 38 seen from the normal direction and the orthographic projection area of the anode porous substrate 15 seen from the normal direction is not particularly limited. However, in the above-described embodiment, it is preferable to set the difference in the above orthographic projection area such that the anode catalyst layer 38 can cover the end surface of the anode porous substrate 15 as much as possible. The difference in the above orthographic projection area is dependent on the size of the anode catalyst layer 38, the thickness of the anode porous substrate 15, the positioning accuracy of the gasket 39, and other factors. For example, assuming that the dimensional accuracy of the size of the anode catalyst layer 38 (i.e., the positioning accuracy of the edge of the anode catalyst layer 38) is ±0.1 mm, the thickness of the anode porous substrate 15 is 0.3 mm, and the positioning accuracy of the gasket 39 is ±0.1 mm, it is preferable that the length of the anode catalyst layer 38 in the direction along the surface of the polymer electrolyte membrane 37 (i.e., the length of any one side thereof) be set to be 0.7 mm or more greater, preferably about 0.8 to 0.9 mm greater, than the corresponding length of the anode porous substrate 15 (i.e., the length of the corresponding side thereof). By setting the areas as described above, the below-described effect of preventing the occurrence of MCO and other phenomenon can be fully exerted.

The anode catalyst layer 38 does not cover the entire end surface of the anode diffusion layer 16. Because of this, to put it accurately, there is a portion where the anode porous substrate 15 and the polymer electrolyte membrane 37 are facing to each other with a clearance interposed therebetween (i.e., a portion where the anode catalyst layer 31 is not present). This may cause the phenomenon (e.g., MCO) in which part of the fuel supplied from the fuel flow channel 22 to the anode porous substrate 15 reaches the polymer electrolyte membrane 37 without passing through the anode catalyst layer 31, permeates through the polymer electrolyte membrane 37, and is oxidized in the cathode catalyst layer 13.

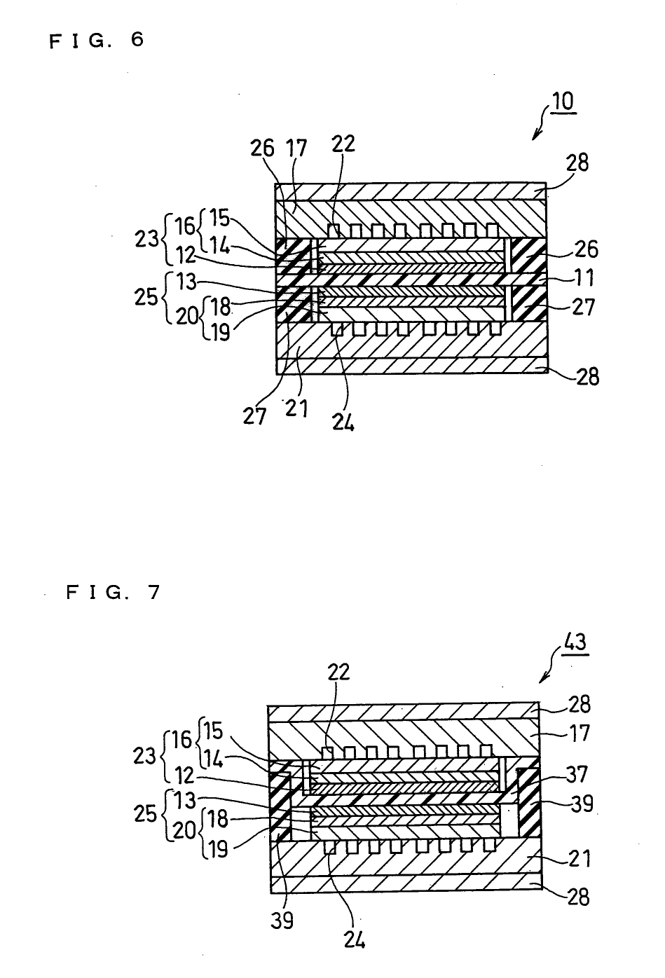

However, as is evident from the comparison with the configuration of Comparative Example 1 (FIG. 6) as described below, since the polymer electrolyte membrane 37 is provided with the periphery thereof being bent, even if the fuel reaches the polymer electrolyte membrane 37 without passing through the anode catalyst layer 31, it is difficult for the fuel to permeate through the polymer electrolyte membrane 37. As such, the degree of MCO and other phenomenon, if occurs, is very low. In order to reliably prevent the MCO and other phenomenon, it is preferable that the entire end surface of the anode diffusion layer 16 is covered by the anode catalyst layer 38 and the like.

The configuration of the fuel cell 36 shown in FIG. 4 is suitable for improving the fuel utilization efficiency, and the power generation performance such as the power generation voltage and power generation efficiency.

Referring to FIG. 5 showing a fifth embodiment, a fuel cell 40, like the fuel cell 36 of FIG. 4, includes the anode-side separator 17, the anode 23, the polymer electrolyte membrane 37, the cathode 25, the cathode-side separator 21, the gasket 39 interposed between the pair of the separators 17 and 21 and the polymer electrolyte membrane 11, and the pair of the end plates 28.

The anode 23 has an anode catalyst layer 41 being in contact with the polymer electrolyte membrane 37, and the anode diffusion layer 16. The anode diffusion layer 16 further has an anode water-repellent layer 42 being in contact with the anode catalyst layer 41, and the anode porous substrate 15.

The anode water-repellent layer 42 covers the entire end surface of the anode porous substrate 15.

The entire end surface of the anode porous substrate 15 can be covered with the anode water-repellent layer 42 by forming the anode water-repellent layer 42 in the same manner as forming the anode water-repellent layer 35 in the fuel cell 34 of FIG. 3.

The area of the anode catalyst layer 41 formed on the polymer electrolyte membrane 37 is set to be large as compared with the area of the anode diffusion layer 16 (particularly, the anode porous substrate 15) so that the end surface of the anode diffusion layer 16 can be covered with the anode catalyst layer 41. Accordingly, in the direction normal to the anode porous substrate 15, the orthographic projection area of the anode catalyst layer 41 is larger than the orthographic projection area of the anode porous substrate 15.

The magnitude of the difference between the orthographic projection area of the anode catalyst layer 41 seen from the normal direction and the orthographic projection area of the anode porous substrate 15 seen from the normal direction is not particularly limited. However, in the above-described embodiment, it is preferable to set the relationship between the length of the anode catalyst layer 41 in the direction along the surface of the polymer electrolyte membrane 37 (i.e., the length of any one side thereof) and the corresponding length of the anode porous substrate 15 (i.e., the length of the corresponding side thereof) to be the same as the relationship between the lengths of the anode catalyst layer 38 and the anode porous substrate 15 in the fuel cell 36 of FIG. 4.

The configuration of the fuel cell 40 shown in FIG. 5 is suitable for improving the fuel utilization efficiency, and the power generation performance such as the power generation voltage and power generation efficiency.

### EXAMPLES

The fuel cell of the present invention is hereinafter described with reference to Examples and Comparative Examples. It should be noted, however, these Examples are not to be construed as limiting the present invention.

### Example 1

As Example 1, the fuel cell according to the first embodiment as described above was fabricated (see FIG. 1).

For the anode catalyst powder forming the anode catalyst layer 31, a powder comprising conductive carbon particles having an average primary particle size of 30 nm with a platinum-ruthenium alloy (atomic ratio Rt:Ru=1:1) adhering thereto, and containing the platinum-ruthenium alloy in a ratio of 50% by weight was used. For the cathode catalyst powder forming the cathode catalyst layer 13, a powder comprising conductive carbon particles having an average primary particle size of 30 nm with platinum adhering thereto, and containing the platinum in a ratio of 50% by weight was used. For the polymer electrolyte membrane 11, a 178-μm-thick fluorine-based polymer membrane (a film made of a base of a perfluorosulfonic acid/polytetrafluoroethylene copolymer (H⁺ type), product name: “Nafion (registered trademark) 117”, available from E.I. du Pont de Nemours and Company) was used.

First, 10 g of the foregoing anode catalyst powder and 100 g of dispersion containing a perfluorosulfonic acid/polytetrafluoroethylene copolymer (H⁺ type) (product name: Nafion dispersion, “Nafion (registered trademark) 5 wt % solution”, available from E.I. du Pont de Nemours and Company) were mixed together with an appropriate amount of water and stirred together, followed by deaerating, whereby an ink for forming an anode catalyst layer was prepared. The ink for forming an anode catalyst layer thus prepared was sprayed onto one surface of the polymer electrolyte membrane 11 by a spray method using an air brush, while the surface of the polymer electrolyte membrane 11 was kept at a temperature of 60° C. As a result, the sprayed ink for forming an anode catalyst layer dried as it is applied to the surface of the polymer electrolyte membrane 11, forming the anode catalyst layer 31. The size of the anode catalyst layer 31 was adjusted by masking before spraying, to be a 61 mm square.

Next, 10 g of the foregoing cathode catalyst powder and 100 g of dispersion containing a perfluorosulfonic acid/polytetrafluoroethylene copolymer (H⁺ type) (the foregoing product name: “Nafion (registered trademark) 5 wt % solution”) were mixed together with an appropriate amount of water and stirred together, followed by deaerating, whereby an ink for forming a cathode catalyst layer was prepared. The ink for forming a cathode catalyst layer thus obtained was sprayed onto the other surface of the polymer electrolyte membrane 11 (i.e., the surface opposite to the surface on which the anode catalyst layer 31 was formed) in the same manner as in forming the anode catalyst layer 31. The size of the cathode catalyst layer 13 was adjusted by masking before spraying, to be a 60 mm square. The mutual positional relationship between the anode catalyst layer 31 and the cathode catalyst layer 13 was set such that the centers thereof (i.e., the points of intersection of diagonal lines of these catalyst layers) coincided with each other in the thickness direction of the polymer electrolyte membrane 11.

A carbon paper (product name: “TGP-H-090”, thickness: about 30 μm, available from Toray Industries, Inc.) having been subjected to water repellent treatment was immersed in a diluted PTFE dispersion (product name: “D-1”, available from DAIKIN INDUSTRIES, LTD.) for 1 minute, and then dried in a 100° C. hot air dryer, followed by baking for 2 hours in a 270° C. electric furnace. In such a manner, the anode porous substrate 15 containing PTFE in a ratio of 10% by weight was obtained.

The cathode porous substrate 19 containing PTFE in a ratio of 10% by weight was obtained in the same manner as the anode porous substrate 15 except that a carbon cloth (product name: “AvCarb (trademark) 1071HCB”, available from Ballard Material Products Inc.) was used in place of the carbon paper having been subjected to water repellent treatment, by immersing the carbon cloth in the PTFE dispersion, followed by drying and baking.

An acetylene black powder and a PTFE dispersion (the foregoing product name: “D-1”) were mixed and stirred together, to prepare an ink for forming a water-repellent layer in which the solid content of PTFE was 10% by weight and the content of acetylene black was 90% by weight. The ink for forming a water-repellent layer thus prepared was sprayed onto one surface of the anode porous substrate 15 by a spray method using an air brush, and dried in a 100° C. constant-temperature oven, followed by baking for 2 hours in a 270° C. electric furnace to remove the surfactant. In such a manner, the anode water-repellent layer 14 was formed. The cathode water-repellent layer 18 was obtained in the same manner as described above by spraying the ink for forming a water-repellent layer on the other surface of the cathode porous substrate 19, followed by drying and baking.

The anode diffusion layer 16 composed of the anode porous substrate 15 and the anode water-repellent layer 14, and the cathode diffusion layer 20 composed of the cathode porous substrate 19 and the cathode water-repellent layer 18 were each formed into a 60 mm square using cutting dies.

Subsequently, the anode diffusion layer 16, the CCM, and the cathode diffusion layer 20 obtained in the above were stacked together such that the anode and cathode water repellent layers 14 and 18 were facing the anode and cathode catalyst layers 31 and 13 of the CCM, respectively. The stack was placed in a heat press machine with the temperature set at 125° C., and pressed at a pressure of 5 MPa for 1 minute to be bonded together, whereby a membrane electrode assembly (MEA) was produced.

In stacking the anode and cathode diffusion layers 16 and 20 and the CCM, the positioning was carried out such that the center of the anode catalyst layer 31 (hereinafter, in each of the layers forming the MEA, the center of a layer refers to the point of intersection of diagonal lines of the layer) and the center of the anode diffusion layer 16 including the anode water-repellent layer 14 coincided with each other. Even when stacked in such a manner, the centers of the layers forming the MEA were more or less displaced from one another. However, the result of measurement of the distance between an end side of the anode catalyst layer 31 and the corresponding end side of the anode diffusion layer 16 under an optical microscope showed that the distances measured at four sides were 0.3, 0.4, 0.7, and 0.6 mm. In other words, at all four sides, the anode catalyst layer 31 was present between the anode diffusion layer 16 and the polymer electrolyte membrane 11.

A 0.25-mm-thick sheet of ethylene propylene diene rubber (EPDM) was cut into a 120 mm square, and then a 62-mm-square cut-out in which the MEA was to be positioned was provided in the center thereof. The two gaskets 26 and 27 thus obtained were disposed so as to surround the MEA both in the anode 23 side and in the cathode 25 side.

The anode-side separator 17 and the cathode-side separator 21 were produced by providing the fuel flow channel 22 for supplying methanol and the air flow channel 24 for supplying oxygen each on the surface of a 2-mm-thick graphite sheet. The anode-side separator 17 and the cathode-side separator 21 were disposed such that the fuel and air flow channels 22 and 24 were facing the anode diffusion layer 16 and the cathode diffusion layer 20, respectively. The fuel flow channel 22 and the air flow channel 24 were formed such that the cross section thereof was of a 1-mm-square shape. The fuel flow channel 22 and the air flow channel 24 were serpentine channels with a series of turns running uniformly over the surfaces of the MEA.

The MEA sandwiched between the pair of the separators 17 and 21 was further sandwiched between a pair of the end plates 28 each made of a 1-cm-thick stainless steel sheet. Between the end plate 28 and the separator 17 and between the end plate 28 and the separator 21, a current collector sheet made of a gold-plated 2-mm-thick copper sheet and an insulating sheet were disposed in this order from the separator 17 or 21 side, and connected to an electronic load apparatus. The end plates 28 were clamped using bolts, nuts and springs, whereby a unit cell of a fuel cell (DMFC) was produced. It should be noted that in FIG. 1 schematically showing the first embodiment, the current collector sheet and the insulating sheet are not shown. This applies to the other drawings.

### Example 2

As Example 2, the fuel cell according to the second embodiment as described above was fabricated (see FIG. 2).

The anode diffusion layer 16 was produced in the same manner as in Example 1 and cut into a 60 mm square. Subsequently, an ink for forming an anode catalyst layer prepared in the same manner as in Example 1 was applied onto the surface of the anode diffusion layer 16 in the anode water-repellent layer 14 side by a spray method. In this process, the ink was applied onto the anode diffusion layer 16 with the end surface being left unprotected by masking or the like. By doing this, the ink for forming an anode catalyst layer was also adhered onto the end surface of the anode diffusion layer 16. In other words, the anode catalyst layer 33 was formed not only on the surface of the anode diffusion layer 16 in the anode water-repellent layer 14 side but also on the end surface thereof. Further, the entire end surface of the anode diffusion layer 16 was covered with the anode catalyst layer 33.

A unit cell of a fuel cell (DMFC) was produced in the same manner as in Example 1 except the above.

### Example 3

As Example 3, the fuel cell according to the third embodiment as described above was fabricated (see FIG. 3).

The anode porous substrate 15 was produced in the same manner as in Example 1 and cut into a 60 mm square. Subsequently, an ink for forming an anode water-repellent layer was applied onto the surface of the anode porous substrate 15 by a spray method. In this process, the ink was applied onto the anode porous substrate 15 with the end surface being left unprotected by masking or the like. By doing this, the ink for forming an anode water-repellent layer was also adhered onto the end surface of the anode porous substrate 15. In other words, the anode water-repellent layer 35 was formed not only on the surface of the anode porous substrate 15 in the anode catalyst layer 33 side but also on the end surface thereof. Further, the entire end surface of the anode porous substrate 15 was covered with the anode water-repellent layer 35.

A unit cell of a fuel cell (DMFC) was produced in the same manner as in Example 1 except the above.

### Example 4

As Example 4, the fuel cell according to the fourth embodiment as described above was fabricated (see FIG. 4).

An MEA was produced in the same manner as in Example 1. The distances between an end side of the anode catalyst layer 38 and the corresponding end side of the anode diffusion layer 16 measured at four sides were 0.3, 0.4, 0.7, and 0.6 mm, which were the same as those in Example 1. For the gasket, a 0.50-mm-thick EPDM sheet was used by cutting it into a 120 mm square and providing the center thereof a 62-mm-square cut-out in which the MEA was to be positioned. The gasket 39 thus obtained was disposed so as to surround the MEA only between the polymer electrolyte membrane 11 and the cathode-side separator 21.

In such a manner, a unit cell of a fuel cell (DMFC) was produced. In this unit cell, the anode catalyst layer 38 was positioned so as to cover the end surface of the anode diffusion layer 16 as shown in FIG. 4. The entire end surface of the anode diffusion layer 16 was not covered with the anode catalyst layer 38.

### Example 5

As Example 5, the fuel cell according to the fifth embodiment as described above was fabricated (see FIG. 5).

The anode diffusion layer 16 was produced in the same manner as in Example 3, and an MEA was produced in the same manner as in Example 1. The distances between an end side of the anode catalyst layer 41 and the corresponding end side of the anode diffusion layer 16 measured at four sides were 0.3, 0.4, 0.7, and 0.6 mm, which were the same as those in Example 1. For the gasket, a gasket produced in the same manner as in Example 4 was used. The gasket 39 was placed so as to surround the MEA between the polymer electrolyte membrane 11 and the cathode-side separator 21.

In such a manner, a unit cell of a fuel cell (DMFC) was produced. In this unit cell, the anode catalyst layer 41 and the anode water-repellent layer 42 were positioned so as to cover the end surface of the anode porous substrate 15.

### Comparative Example 1

A fuel cell having a structure as shown in FIG. 6 was fabricated. Specifically, in a fuel cell 10 of Comparative Example 1, an anode catalyst layer 12 was formed on the polymer electrolyte membrane 11, the anode catalyst layer 12 being formed into a 60 mm square. A unit cell of a fuel cell (DMFC) was produced in the same manner as in Example 1 except the above.

The positional relationship between the end sides of the anode catalyst layer 12 and the end sides of the anode diffusion layer 16 in the unit cell of Comparative Example 1 was checked. The results showed that in one side, the end side of the anode catalyst layer 12, with reference to the midpoint of the end side thereof, extended outwardly from the corresponding end side of the anode diffusion layer 16 by 0.2 mm, and in another side, extended outwardly by 0.1 mm. On the other hand, in the sides opposite to the foregoing sides, the end sides of the anode catalyst layer 12, with reference to the midpoint of each end side thereof, recessed inwardly from the corresponding end sides of the anode diffusion layer 16 by 0.2 mm and 0.1 mm. In other words, in two sides, the anode catalyst layer was not present between the anode diffusion layer and the electrolyte membrane.

### Comparative Example 2

A fuel cell 43 as shown in FIG. 7 was fabricated as Comparative Example 2.

An MEA was produced in the same manner as in Comparative Example 1. The same gasket 39 as used in Example 4 was placed between the polymer electrolyte membrane 11 and the cathode-side separator 21, to produce a unit cell of a fuel cell (DMFC).

The positional relationship between the end sides of the anode catalyst layer 12 and the end sides of the anode diffusion layer 16 in the unit cell of Comparative Example 2 was the same as in Comparative Example 1.

Physical Property Test

With respect to the above Examples and Comparative Examples, the amount of methanol crossover during operation was measured, from which the fuel unitization efficiency was calculated.

The fuel cell was operated as follows. While an aqueous 4 mol/L methanol solution serving as the fuel was supplied to the anode at a flow rate of 0.3 cm³/min with a tube type pump, unhumidified air was supplied to the cathode at a flow rate of 300 cm³/min with a mass flow controller. The temperature of each fuel cell was controlled to be 60° C. using an electric wire heater and a temperature controller. Thereafter the fuel cell was connected to an electronic load apparatus “PLZ164WA” (available from Kikusui Electronics Corporation), and subjected to continuous operation at a constant current density of 200 mA/cm².

A gas-liquid mixed fluid discharged from the anode side comprising the aqueous methanol solution containing residual fuel left unused and carbon dioxide was introduced into a gas collection container filled with pure water. The container was placed in an ice-water bath to cool the fluid, thereby to collect gaseous and liquid ethanol for the duration of 1 hour. Thereafter, the amount of methanol in the gas collection container was measured by gas chromatography, and the material balance at the anode was calculated, whereby an amount of methanol crossover (i.e., an amount of MCO) was determined. Specifically, the amount of MCO was determined by subtracting the total of an amount of methanol discharged and collected and an amount of methanol consumed at the electrode calculated from an amount of generated current from an amount of methanol supplied to the anode. Here, the amount of MCO was converted into an amount of current that would have been produced when the foregoing amount of MCO was oxidized at the electrode. The fuel utilization rate was calculated from the following formula.

Fuel utilization rate=(Generated current)/(Generated current+Amount of MCO converted into current)

The results of the above test are shown in Table 1.

TABLE 1

| | | | Fuel |
|---|---|---|---|
| | Structure | Amount of MCO | utilization |
| | of cell | [mA/cm²] | rate |
| Ex. 1 | FIG. 1 | 33.8 | 85.5% |
| Ex. 2 | FIG. 2 | 29.9 | 87.0% |
| Ex. 3 | FIG. 3 | 45.1 | 81.6% |
| Ex. 4 | FIG. 4 | 36.2 | 84.7% |
| Ex. 5 | FIG. 5 | 32.4 | 86.1% |
| Com. Ex. 1 | FIG. 6 | 66.5 | 75.0% |
| Com. Ex. 2 | FIG. 7 | 87.8 | 69.5% |

As is evident from Table 1, in the fuel cells of Example 1 to 3, the amounts of MCO were small and the fuel cell utilization rates were high as compared with those in the fuel cell of Comparative Example 1. Comparison among Examples 1 to 3 shows that in Example 2, in which the end surface of the anode diffusion layer 16 was covered with the anode catalyst layer 33, the amount of MCO was further reduced as compared with that in Example 1.

Further, comparison of the amount of MCO between Comparative Example 1 and Comparative Example 2 shows that the amount of MCO in Comparative Example 2 was larger than that in Comparative Example 1. This indicates that the smaller the distance between the polymer electrolyte membrane 11 and the anode diffusion layer 16 is, the more significantly the amount of MCO around the anode 23 is increased.

In the fuel cells of Examples 4 and 5, the MCO was reduced as in the fuel cells of Examples 1 and 2. It is confirmed, therefore, that the configurations of Examples 4 and 5 remarkably decreases the amount of MCO around the anode 23. Further, comparison between Example 4 and Example 5 shows that the amount of MCO in Example 5, in which the end surface of the anode porous substrate 15 was covered with the anode water-repellent layer (14 or 35), was smaller. This indicates that covering the end surface of the anode porous substrate 15 with the anode catalyst layer (31 or 38) and covering the end surface of the anode porous substrate 15 with the anode water-repellent layer (14 or 35) produce a synergetic effect.

As described above, the fuel cell of the present invention can provide a high fuel utilization rate as compared with that of the conventional structure, and thus to provide a high energy conversion efficiency.

The fuel cell of the present invention is useful as a power source for small-sized electronic devices such as laptop personal computers, cell phones, and personal digital assistants (PDAs). The fuel cell of the present invention can also be applied as a power source for electric scooters.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. A fuel cell comprising:
a membrane electrode assembly including a polymer electrolyte membrane with hydrogen ion conductivity, and an anode and a cathode sandwiching said polymer electrolyte membrane;
an anode-side separator having a fuel flow channel for supplying a fuel to said anode;
a cathode-side separator having an oxidant flow channel for supplying an oxidant to said cathode; and
a gasket being interposed at least either between said anode-side separator and a periphery of said polymer electrolyte membrane or between said cathode-side separator and the periphery of said polymer electrolyte membrane so as to surround said anode or said cathode, and compressing, together with said anode-side separator and said cathode-side separator, said polymer electrolyte membrane in its thickness direction,
wherein said anode includes an anode catalyst layer being in contact with said polymer electrolyte membrane, and an anode diffusion layer being in contact with said anode-side separator,
said anode diffusion layer includes an anode water-repellent layer being in contact with said anode catalyst layer, and an anode porous substrate being in contact with said anode-side separator, and
an orthographic projection area of said anode catalyst layer seen from the direction normal to said membrane electrode assembly is larger than an orthographic projection area of said anode porous substrate seen from the direction normal to said membrane electrode assembly.

2. The fuel cell in accordance with claim 1, wherein said anode catalyst layer covers at least part of an end surface of said anode diffusion layer.

3. The fuel cell in accordance with claim 1, wherein said anode water-repellent layer covers at least part of an end surface of said anode porous substrate.

4. The fuel cell in accordance with claim 2, wherein said gasket is interposed between said cathode-side separator and the periphery of said polymer electrolyte membrane; and the periphery of said polymer electrolyte membrane is bent so as to be in contact with said anode-side separator and to cover a portion of said anode catalyst layer covering at least part of an end surface of said anode diffusion layer.

5. The fuel cell in accordance with claim 4, wherein said gasket compresses the periphery of said polymer electrolyte membrane onto said anode-side separator.

6. The fuel cell in accordance with claim 2, wherein said anode catalyst layer covers an entire end surface of said anode diffusion layer.

7. The fuel cell in accordance with claim 3, wherein said anode water-repellent layer covers an entire end surface of said anode porous substrate.
